(19) United States
(12) Patent Application Publication
(10) Pub. No.: US 2016/0043389 A1
(43) Pub. Date: Feb. 11, 2016

(54) NON-AQUEOUS ELECTROLYTE SECONDARY BATTERY

(71) Applicant: SANYO ELECTRIC CO., LTD., Daito-shi, Osaka (JP)

(72) Inventors: Masaki DEGUCHI, Tokushima (JP); Kentaro TAKAHASHI, Hyogo (JP); Masaya UGAJI, Tokushima (JP)

(73) Assignee: SANYO Electric Co., Ltd., Daito-shi, Osaka (JP)

(21) Appl. No.: 14/777,036

(22) PCT Filed: Mar. 6, 2014
(86) PCT No.: PCT/JP2014/001238

§ 371 Date: Sep. 15, 2015

(30) Foreign Application Priority Data
Mar. 19, 2013 (JP) 2013-055861

(51) Int. Cl. H01M 4/36; H01M 4/525; H01M 4/485; H01M 4/505; H01M 10/0567; H01M 10/052

(52) U.S. Cl. CPC H01M 4/366; H01M 10/0567; H01M 10/052; H01M 4/485; H01M 4/505; H01M 4/525; H01M 2004/028

(57) ABSTRACT

It is an object of the present invention to provide a nonaqueous electrolyte secondary battery which inhibits the oxidative decomposition of an electrolytic solution in a high-temperature environment and has markedly improved high-temperature storage characteristics and cycle characteristics. The nonaqueous electrolyte secondary battery of the present invention includes a positive electrode plate containing a positive electrode active material, a negative electrode plate containing a negative electrode active material, and a nonaqueous electrolyte, in which the positive electrode active material is a lithium transition metal complex oxide, at least one selected from rare-earth hydroxide and rare-earth oxyhydroxide is present on a surface of the positive electrode active material, and the nonaqueous electrolyte contains a fluoroarene.

### TECHNICAL FIELD

The present invention relates to a nonaqueous electrolyte secondary battery and particularly to the improvements of a positive electrode active material and a nonaqueous electrolyte.

### BACKGROUND ART

With the proliferation of mobile devices, such as cellular phones, mobile personal computers, and portable music players, nonaqueous electrolyte secondary batteries, such as lithium-ion secondary batteries, have been widely used as power supplies to drive them.

In particular, higher capacities of nonaqueous electrolyte secondary batteries are requisite for higher performance in the future. Regarding an element technique for higher capacities, an increase in the charge cutoff voltage of nonaqueous electrolyte secondary batteries has been studied.

When nonaqueous electrolyte secondary batteries are charged to high voltages, the crystal structures of positive electrode active materials are unstable, so that oxygen molecules or oxygen radicals are liable to occur. This causes the oxidative decomposition of electrolytic solutions and problems of a reduction in cycle characteristics and an increase in the thickness of batteries due to gas generation.

As measures to solve these problems, for example, PTL 1 discloses that the cycle characteristics are improved by the addition of a fluorine-containing aromatic compound to a nonaqueous electrolyte.

### CITATION LIST

### Patent Literature

PTL 1: Japanese Published Unexamined Patent Application No. 2003-132950

### SUMMARY OF INVENTION

### Technical Problem

Although the fluorine-containing aromatic compound is added to the nonaqueous electrolyte as described in PTL 1, the effect of significantly improving cycle characteristics is not provided in nonaqueous electrolyte secondary batteries charged at high charging voltages. The crystal structures of positive electrode active materials are unstable. Thus, in the cases where these batteries are stored in a high-temperature environment and where charge and discharge are repeated, a large amount of gas is generated, thereby disadvantageously reducing the charge-discharge capacities of batteries.

It is an object of the present invention to provide a nonaqueous electrolyte secondary battery which solves the foregoing problems, inhibits the oxidative decomposition of an electrolytic solution in a high-temperature environment, and has markedly improved high-temperature storage characteristics and cycle characteristics.

### Solution to Problem

To solve the foregoing problems, a nonaqueous electrolyte secondary battery of the present invention includes a positive electrode plate containing a positive electrode active material, a negative electrode plate containing a negative electrode active material, and a nonaqueous electrolyte, in which the positive electrode active material is a lithium transition metal complex oxide, at least one selected from rare-earth hydroxide and rare-earth oxyhydroxide is present on a surface of the positive electrode active material, and the nonaqueous electrolyte contains a fluoroarene.

The structure results in the inhibition of the oxidative decomposition of the electrolytic solution in a high-temperature environment and marked improvement in high-temperature storage characteristics and cycle characteristics.

A surface of the positive electrode active material is coated with at least one selected from rare-earth hydroxide and rare-earth oxyhydroxide, thereby inhibiting the oxidative decomposition of the electrolytic solution in a high-temperature environment and improving the high-temperature storage characteristics.

However, by performing this coating step, alkali components, such as LiOH and Li₂CO₃, present on the surfaces of the positive electrode active material are washed to reduce the charge-transfer resistance on the surfaces of the positive electrode active material, thereby reducing polarization during charge. The cycle operation causes an imbalance in capacity degradation between the positive electrode and the negative electrode. Thus, metallic lithium is liable to be deposited on the negative electrode at the end stage of the cycle operation.

In the case where the nonaqueous electrolyte contains a fluoroarene, the fluoroarene reacts immediately with metallic lithium deposited on the negative electrode to form an inert LiF film. This suppresses the side reaction of the metallic lithium deposited on the nonaqueous electrolyte with a nonaqueous solvent, such as a chain carbonate, to improve the cycle characteristics.

As described above, in the case where at least one selected from rare-earth hydroxide and rare-earth oxyhydroxide is present on the surface of the positive electrode active material and where the nonaqueous electrolyte contains the fluoroarene, the high-temperature storage characteristics and the cycle characteristics are markedly improved.

### Advantageous Effects of Invention

According to the present invention, it is possible to markedly improve the high-temperature storage characteristics and the cycle characteristics of a nonaqueous electrolyte secondary battery.

### BRIEF DESCRIPTION OF DRAWINGS

FIG. 1 is a schematic perspective view of a nonaqueous electrolyte secondary battery according to an embodiment of the present invention.

### DESCRIPTION OF EMBODIMENTS

While a nonaqueous electrolyte secondary battery according to embodiments of the present invention will be described in detail below with reference to the drawing, the present invention is not particularly limited to the embodiments. Various changes may be made without departing from the scope of the present invention.

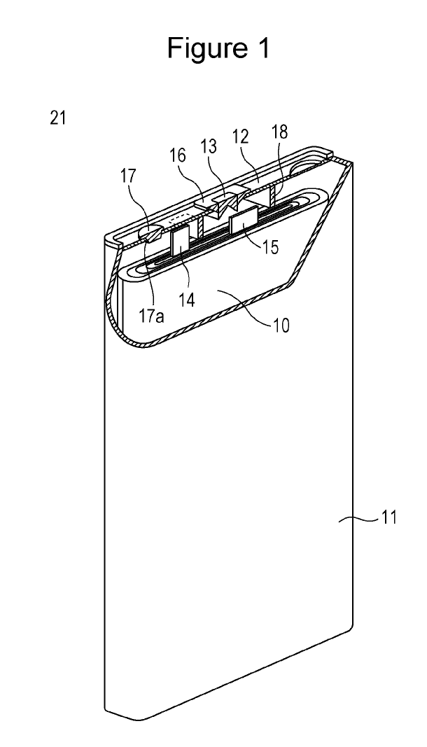

FIG. 1 is a schematic perspective view of a prismatic nonaqueous electrolyte secondary battery according to an embodiment of the present invention. In FIG. 1, for the purpose of illustrating a partial structure of a battery 21, the battery 21 in which a portion thereof is cut away is illustrated. The battery 21 is a prismatic battery including a flat spiral electrode body 10 and a nonaqueous electrolyte (not illustrated) arranged in a prismatic battery case 11.

A positive electrode plate and a negative electrode plate are wound with a separator (all of them are not illustrated) provided therebetween to produce a spiral electrode body. The resulting spiral electrode body is pressed laterally into a flat shape, thereby producing the flat spiral electrode body 10.

One end portion of a positive electrode lead 14 is connected to the positive electrode core of the positive electrode plate. The other end portion thereof is connected to a seal plate 12 that functions as a positive electrode terminal. One end portion of a negative electrode lead 15 is connected to the negative electrode core of the negative electrode plate. The other end portion thereof is connected to a negative electrode terminal 13. A gasket 16 is arranged between the seal plate 12 and the negative electrode terminal 13 and insulates them from each other. A frame 18 typically composed of an insulating material, such as polypropylene, is arranged between the seal plate 12 and the flat spiral electrode body 10 to insulate the seal plate 12 from the negative electrode lead 15.

The seal plate 12 is connected to the opening portion of the prismatic battery case 11, so that the prismatic battery case 11 is sealed therewith. The seal plate 12 has an inlet 17a. After the nonaqueous electrolyte is injected into the prismatic battery case 11, the inlet 17a is plugged with a sealing plug 17.

### Experimental Example 1

### 1. Production of Positive Electrode Plate

Lithium cobaltate containing 0.5% by mole Mg and 0.5% by mole A1 dissolved therein was used as positive electrode active material particles. Into 3 L of deionized water, 1000 g of the positive electrode active material particles were charged. An aqueous solution of erbium nitrate in which 5.79 g of erbium nitrate pentahydrate was dissolved in 200 mL of deionized water was added to the mixture with the mixture being stirred. A 10% by mass aqueous solution of sodium hydroxide was appropriately added thereto in such a manner that the solution had a pH of 9, thereby coating the surfaces of the positive electrode active material particles with erbium hydroxide. The resulting particles were filtered by suction to recover the treated particles. The treated particles were dried at 120° C. to provide the positive electrode active material particles with the surfaces coated with erbium hydroxide.

The positive electrode active material particles with the surfaces coated with erbium hydroxide were heat-treated at 300° C. for 5 hours in an air atmosphere, thereby producing a positive electrode active material in which the surfaces of the positive electrode active material particles were coated with erbium compound particles composed of erbium hydroxide and erbium oxyhydroxide.

In the positive electrode active material, the proportion of the erbium element (Er) in the erbium compounds with which the surfaces were coated was 0.15% by mole with respect to the positive electrode active material particles composed of lithium cobaltate. Most of erbium hydroxide with which the surfaces of the positive electrode active material particles were coated was changed into erbium oxyhydroxide.

SEM observation of the positive electrode active material revealed that most erbium compound particles with which the surfaces of the positive electrode active material particles were coated had a particle diameter of 100 nm or less. Furthermore, the surfaces of the positive electrode active material particles were coated with the erbium compound particles that were in a dispersed state.

Next, the positive electrode active material, acetylene black serving as a conductive agent, and an NMP solution containing polyvinylidene fluoride serving as a binder dissolved therein were mixed together and stirred with a mixer/stirrer (Combi Mix, manufactured by Tokusyu Kika Kogyo Co., Ltd.), thereby preparing a positive electrode mixture slurry. In this case, the mass ratio of the positive electrode active material to the conductive agent to the binder was 97.6:1.2:1.2. The positive electrode mixture slurry was uniformly applied to both surfaces of 15-μm-thick aluminum foil serving as a positive electrode collector, dried, and rolled with reduction rolls to form positive electrode mixture layers. The positive electrode mixture layers were cut together with the positive electrode collector into a predetermined shape, thereby providing a positive electrode plate. In the positive electrode plate, the packing density of the positive electrode active material was 3.80 g/cc. The overall thickness of the positive electrode plate was 120 μm.

### 2. Production of Negative Electrode Plate

Artificial graphite serving as a negative electrode active material, CMC serving as a thickener, and SBR serving as a binder were mixed together in an aqueous solution in a mass ratio of 98:1:1, thereby preparing a negative electrode mixture slurry. The negative electrode mixture slurry was uniformly applied to both surfaces of 8-μm-thick copper foil serving as a negative electrode collector. The resulting coating films were dried and rolled with reduction rolls to negative electrode mixture layers. The negative electrode mixture layers were cut together with the negative electrode collector into a predetermined shape, thereby providing a negative electrode plate. In the negative electrode plate, the packing density of the negative electrode active material was 1.50 g/cc. The overall thickness of the negative electrode plate was 130 μm.

### 3. Preparation of Nonaqueous Electrolyte

LiPF₆ serving as an electrolyte salt was dissolved in a solvent mixture in a proportion of 1.2 mol/L (mole/liter) to prepare a nonaqueous electrolyte, the solvent mixture containing ethylene carbonate (EC), propylene carbonate (PC), diethyl carbonate (DEC), methyl trimethylacetate (MTMA), and monofluorobenzene (FB) mixed in a ratio of 30:1:54:5:10 (mass ratio). The viscosity of the nonaqueous electrolyte was measured with a rotational viscometer and found to be 4.8 mPa·s at 25° C.

### 4. Production of Electrode Body

The positive electrode plate and the negative electrode plate were spirally wound with a 14-μm-thick separator formed of a microporous polyethylene film provided therebetween and pressed vertically, thereby producing a flat spiral electrode body having a substantially elliptical-shaped cross section.

### 5. Production of Nonaqueous Electrolyte Secondary Battery

A nonaqueous electrolyte secondary battery illustrated in FIG. 1 was produced with the flat spiral electrode body and the nonaqueous electrolyte. The design capacity of the nonaqueous electrolyte secondary battery was 850 mAh when the nonaqueous electrolyte secondary battery was charged to 4.30 V. This battery is referred to as “battery A1”.

### Experimental Example 2

Battery A2 was produced as in Experimental example 1, except that FB was not used and the content of DEC was changed to 64% by mass.

### Experimental Example 3

Battery A3 was produced as in Experimental example 1, except that the surfaces of the positive electrode active material particles composed of lithium cobaltate were not coated with the erbium compounds.

### Experimental Example 4

Battery A4 was produced as in Experimental example 1, except that FB was not used, the content of DEC was changed to 64% by mass, and the surfaces of the positive electrode active material particles composed of lithium cobaltate were not coated with the erbium compounds.

### 6. Evaluation of Battery

### (Measurement of Cycle Capacity Retention Rate)

The cycle capacity retention rate was measured using 3 cells of each of batteries A1 to A4. Measurement conditions are described below. The battery was charged at a constant current of 850 mA in an atmosphere with a temperature of 45° C. until the voltage reached a charge cutoff voltage of 4.30 V. Furthermore, the battery was charged at a constant voltage of 4.30 V. The charging was completed when the current reached 43 mA. After the charging, the battery was discharged at a constant current of 850 mA until the voltage reached a charge cutoff voltage of 3.0 V. This charge-discharge operation was repeated. The discharge capacity was measured at each cycle. The quiescent time after the charging and the discharging was 10 minutes for each.

The cycle capacity retention rate was determined from the following expression using the discharge capacity at the 3rd cycle and the discharge capacity at the 800th cycle measured as described above.

Cycle capacity retention rate(%)=(discharge capacity

after 800 cycles/discharge capacity after 3 cycles)×100

<Measurement of Return Rate after High-Temperature Storage>

The return rate after high-temperature storage was measured using 3 cells of each of batteries A1 to A4. Measurement conditions are described below. The charge-discharge operation was performed 3 cycles in an atmosphere with a temperature of 25° C. At the 4th cycle, only charging was performed, resulting in the battery in a charged state. The discharge capacity measured at the 3rd cycle was defined as a discharge capacity before storage. Conditions of charging and discharging performed in measuring the return rate after high-temperature storage are the same as the conditions of the measurement of the cycle capacity retention rate, except for the temperature.

The battery in the charged state provided as described above was stored in a high-temperature environment with a temperature of 60° C. for 30 days. Then the battery was cooled to room temperature and discharged in an atmosphere with a temperature of 25° C.

Next, the charge-discharge operation was performed 1 cycle in an atmosphere with a temperature of 25° C. The discharge capacity measured at this time was defined as a discharge capacity after storage. The return rate after high-temperature storage was determined from the following expression using the discharge capacity before storage and the discharge capacity after storage measured as described above.

Return rate after high-temperature storage(%)=

(discharge capacity after storage/discharge capacity before

storage)×100

Table 1 lists the measurement results of batteries A1 to A4. Note that each of the cycle capacity retention rate and the return rate after high-temperature storage listed in Table 1 is the average value of 3 cells for each of batteries A1 to A4.

TABLE 1

| | | | | | Return rate |
|---|---|---|---|---|---|
| | | | | Cycle capacity | after high- |
| | Positive electrode active | Coating | | retention rate | temperature |
| | material | element | Fluoroarene | (%) | storage (%) |
| Battery A1 | LiCo_{0.9}Mg_{0.05}Al_{0.05}O₂ | Er | FB | 85.7 | 86.0 |
| Battery A2 | LiCo_{0.9}Mg_{0.05}Al_{0.05}O₂ | Er | — | 41.0 | 85.3 |
| Battery A3 | LiCo_{0.9}Mg_{0.05}Al_{0.05}O₂ | — | FB | 30.9 | 34.5 |
| Battery A4 | LiCo_{0.9}Mg_{0.05}Al_{0.05}O₂ | — | — | 31.1 | 35.1 |

In each of batteries A3 and A4, in which the positive electrode active material particles with the surfaces that were not coated with the erbium compounds were used, the cycle capacity retention rate and the return rate after high-temperature storage were low. The reason for this is presumably that in the nonaqueous electrolyte secondary battery charged at the high charging voltage, the crystal structure of the positive electrode active material is unstable, and a large amount of gas is generated by the oxidative decomposition of the electrolytic solution in the high-temperature environment, thereby reducing the charge-discharge capacity of the battery.

In battery A2, in which the surfaces of the positive electrode active material particles were coated with the erbium compounds and the nonaqueous electrolyte that did not contain a fluoroarene was used, although the return rate after high-temperature storage was high, the cycle capacity retention rate was low. The reason for this is presumably that the charge-transfer resistance on the surfaces of the positive electrode active material was reduced through the coating step, the cycle operation caused an imbalance in capacity degradation between the positive electrode and the negative electrode, and metallic lithium was deposited on the negative electrode at the end stage of the cycle operation to allow the reductive decomposition of the electrolytic solution to proceed, thereby reducing the charge-discharge capacity of the battery.

In battery A1, both of the cycle capacity retention rate and the return rate after high-temperature storage were high, compared with batteries A2 to A4. The reason for this is presumably that the oxidative decomposition of the electrolytic solution on the surfaces of the positive electrode is inhibited to improve the high-temperature storage characteristics and that the reductive decomposition of the electrolytic solution on the surfaces of the negative electrode at the end stage of the cycle operation is inhibited to improve the cycle characteristics.

### Experimental Examples 5 to 12

Batteries A5 to A12 according to Experimental examples 5 to 12 were produced as in Experimental example 1, except that coating elements were used for the surfaces of the positive electrode active material particles composed of lithium cobaltate. Table 2 lists the results of the cycle capacity retention rates and the return rates after high-temperature storage. Table 2 also lists the results of battery A1 in Experimental example 1.

TABLE 2

| | | | | | Return rate |
|---|---|---|---|---|---|
| | | | | Cycle capacity | after high- |
| | Positive electrode active | Coating | | retention rate | temperature |
| | material | element | Fluoroarene | (%) | storage (%) |
| Battery A1 | LiCo_{0.9}Mg_{0.05}Al_{0.05}O₂ | Er | FB | 85.7 | 86.0 |
| Battery A5 | LiCo_{0.9}Mg_{0.05}Al_{0.05}O₂ | Sm | FB | 85.1 | 85.8 |
| Battery A6 | LiCo_{0.9}Mg_{0.05}Al_{0.05}O₂ | Nd | FB | 84.8 | 85.3 |
| Battery A7 | LiCo_{0.9}Mg_{0.05}Al_{0.05}O₂ | Yb | FB | 84.7 | 85.0 |
| Battery A8 | LiCo_{0.9}Mg_{0.05}Al_{0.05}O₂ | Tb | FB | 84.0 | 84.9 |
| Battery A9 | LiCo_{0.9}Mg_{0.05}Al_{0.05}O₂ | Dy | FB | 83.3 | 84.8 |
| Battery A10 | LiCo_{0.9}Mg_{0.05}Al_{0.05}O₂ | Ho | FB | 82.5 | 84.5 |
| Battery A11 | LiCo_{0.9}Mg_{0.05}Al_{0.05}O₂ | Tm | FB | 82.6 | 84.3 |
| Battery A12 | LiCo_{0.9}Mg_{0.05}Al_{0.05}O₂ | Lu | FB | 82.9 | 84.1 |

The results listed in Table 2 demonstrated that in each of batteries A1 and A5 to A12, in which the surfaces of the positive electrode active material were coated with compounds of rare-earth elements present thereon as listed in Table 2, both of the cycle capacity retention rate and the return rate after high-temperature storage were high.

Thus, as each of the rare-earth element compounds present on the surfaces of the positive electrode active material, a hydroxide or oxyhydroxide of at least one selected from Er, Sm, Nd, Yb, Tb, Dy, Ho, Tm, and Lu is preferred.

### Experimental Examples 13 to 20

Batteries A13 to A19 according to Experimental examples 13 to 19 were produced as in Experimental example 1, except that the amount of the coating element (Er) present on the surfaces of the positive electrode active material was changed as listed in Table 3. Table 3 lists the results of the cycle capacity retention rate and the return rate after high-temperature storage. Table 3 also lists the results of battery A1 in Experimental example 1.

TABLE 3

| | | | | Cycle | Return rate |
|---|---|---|---|---|---|
| | | | | capacity | after high- |
| | Positive electrode | | | retention rate | temperature |
| | active material | Coating element | Fluoroarene | (%) | storage (%) |
| Battery A13 | LiCo_{0.9}Mg_{0.05}Al_{0.05}O₂ | Er (0.005 mol %) | FB | 41.5 | 43.8 |
| Battery A14 | LiCo_{0.9}Mg_{0.05}Al_{0.05}O₂ | Er (0.01 mol %) | FB | 80.1 | 80.3 |
| Battery A15 | LiCo_{0.9}Mg_{0.05}Al_{0.05}O₂ | Er (0.05 mol %) | FB | 82.6 | 82.9 |
| Battery A16 | LiCo_{0.9}Mg_{0.05}Al_{0.05}O₂ | Er (0.10 mol %) | FB | 85.0 | 85.3 |
| Battery A1 | LiCo_{0.9}Mg_{0.05}Al_{0.05}O₂ | Er (0.15 mol %) | FB | 85.7 | 86.0 |
| Battery A17 | LiCo_{0.9}Mg_{0.05}Al_{0.05}O₂ | Er (0.20 mol %) | FB | 85.1 | 85.5 |
| Battery A18 | LiCo_{0.9}Mg_{0.05}Al_{0.05}O₂ | Er (0.25 mol %) | FB | 82.5 | 82.7 |
| Battery A19 | LiCo_{0.9}Mg_{0.05}Al_{0.05}O₂ | Er (0.30 mol %) | FB | 80.2 | 80.5 |
| Battery A20 | LiCo_{0.9}Mg_{0.05}Al_{0.05}O₂ | Er (0.32 mol %) | FB | 39.6 | 42.1 |

In battery A13, in which the amount of the coating element was less than 0.01% by mole, the cycle capacity retention rate and the return rate after high-temperature storage were low. In the case of an amount of the coating element of less than 0.01% by mole, presumably, the effect of inhibiting the oxidative decomposition of the electrolytic solution is insufficient in the high-temperature environment, and a large amount of gas was generated by the oxidative decomposition of the electrolytic solution, thereby reducing the charge-discharge capacity of the battery.

In battery A20, in which the amount of the coating element was more than 0.30% by mole, the cycle capacity retention rate and the return rate after high-temperature storage were low. An amount of the coating element more than 0.30% by mole presumably results in a marked increase in charge-transfer resistance on the surfaces of the positive electrode active material to increase the polarization, thereby reducing the charge-discharge capacity of the battery.

In contrast, in each of batteries A1 and A14 to A19, in which the amount of the coating element was in the range of 0.01% to 0.30% by mole, both of the cycle capacity retention rate and the return rate after high-temperature storage were high. This demonstrates that the amount of the coating element is preferably in the range of 0.01% to 0.30% by mole with respect to the positive electrode active material.

### Experimental Examples 21 to 29

Batteries A21 to A29 according to Experimental examples 21 to 29 were produced as in Experimental example 1, except that fluoroarenes listed in Table 4 were used. Table 4 lists the results of the cycle capacity retention rate and the return rate after high-temperature storage. Table 4 also lists the results of battery A1 in Experimental example 1.

TABLE 4

| | | | | Cycle | Return rate |
|---|---|---|---|---|---|
| | | | | capacity | after high- |
| | Positive electrode active | Coating | | retention rate | temperature |
| | material | element | Fluoroarene | (%) | storage (%) |
| Battery A1 | LiCo_{0.9}Mg_{0.05}Al_{0.05}O₂ | Er | FB | 85.7 | 86.0 |
| Battery A21 | LiCo_{0.9}Mg_{0.05}Al_{0.05}O₂ | Er | 1,4-difluorobenzene | 84.2 | 84.5 |
| Battery A22 | LiCo_{0.9}Mg_{0.05}Al_{0.05}O₂ | Er | 1,4,6-trifluorobenzene | 83.8 | 84.2 |
| Battery A23 | LiCo_{0.9}Mg_{0.05}Al_{0.05}O₂ | Er | hexafluorobenzene | 83.5 | 83.7 |
| Battery A24 | LiCo_{0.9}Mg_{0.05}Al_{0.05}O₂ | Er | 4-fluorotoluene | 83.6 | 84.0 |
| Battery A25 | LiCo_{0.9}Mg_{0.05}Al_{0.05}O₂ | Er | 3,5-difluorotoluene | 83.0 | 83.4 |
| Battery A26 | LiCo_{0.9}Mg_{0.05}Al_{0.05}O₂ | Er | 2-fluoro-m-xylene | 81.0 | 81.3 |
| Battery A27 | LiCo_{0.9}Mg_{0.05}Al_{0.05}O₂ | Er | 3-fluoro-o-xylene | 80.7 | 81.1 |
| Battery A28 | LiCo_{0.9}Mg_{0.05}Al_{0.05}O₂ | Er | 1-fluoronaphthalene | 80.5 | 80.9 |
| Battery A29 | LiCo_{0.9}Mg_{0.05}Al_{0.05}O₂ | Er | 2-fluoronaphthalene | 80.2 | 80.6 |

The results listed in Table 4 demonstrated that batteries A21 to A29 containing the fluoroarenes according to Experimental examples 21 to 29 had the same effect as that of battery A1 containing FB according to Experimental example 1. Of these, in each of batteries A1 and A21 to A25 containing the fluorobenzenes and the fluorotoluenes, both of the cycle capacity retention rate and the return rate after high-temperature storage were high. In particular, battery A1 containing fluorobenzene had excellent characteristics.

### Experimental Examples 30 to 36

Batteries A30 to A36 according to Experimental examples 30 to 36 were produced as in Experimental example 1, except that positive electrode active materials listed in Table 5 were used. Table 5 lists the results of the cycle capacity retention rate and the return rate after high-temperature storage. Table 5 also lists the results of battery A1 in Experimental example 1.

In Experimental example 33, a positive electrode active material mixture containing the positive electrode active material used in Experimental example 1 and the positive electrode active material used in Experimental example 31 mixed in a ratio of 80:20 (% by mass) was used.

In Experimental example 34, a positive electrode active material mixture containing the positive electrode active material used in Experimental example 1 and the positive electrode active material used in Experimental example 32 mixed in a ratio of 80:20 (% by mass) was used.

In Experimental example 35, a positive electrode active material mixture containing the positive electrode active material (first active material: coated with the Er element) used in Experimental example 1 and the positive electrode active material (second active material: not coated with the Er element) used in Experimental example 31 mixed in a ratio of 80:20 (% by mass) was used.

In Experimental example 36, a positive electrode active material mixture containing the positive electrode active material (first active material: coated with the Er element) used in Experimental example 1 and the positive electrode active material (second active material: not coated with the Er element) used in Experimental example 32 mixed in a ratio of 80:20 (% by mass) was used.

TABLE 5

| | | | | Cycle | Return rate |
|---|---|---|---|---|---|
| | | | | capacity | after high- |
| | | Coating | | retention | temperature |
| | Positive electrode active material | element | Fluoroarene | rate (%) | storage (%) |
| Battery A1 | LiCo_{0.9}Mg_{0.05}Al_{0.05}O₂ | Er | FB | 85.7 | 86.0 |
| Battery A30 | LiNi_{0.8}Co_{0.15}Al_{0.05}O₂ | Er | FB | 82.0 | 82.3 |
| Battery A31 | LiNi_{1/3}Co_{1/3}Mn_{1/3}O₂ | Er | FB | 83.8 | 84.1 |
| Battery A32 | LiNi_{0.5}Co_{0.2}Mn_{0.3}O₂ | Er | FB | 83.3 | 83.5 |
| Battery A33 | LiCo_{0.9}Mg_{0.05}Al_{0.05}O₂ (80%) | Er | FB | 85.3 | 85.7 |
| | LiNi_{1/3}Co_{1/3}Mn_{1/3}O₂ (20%) | | | | |
| Battery A34 | LiCo_{0.9}Mg_{0.05}Al_{0.05}O₂ (80%) | Er | FB | 85.0 | 85.4 |
| | LiNi_{0.5}Co_{0.2}Mn_{0.3}O₂ (20%) | | | | |
| Battery A35 | first: LiCo_{0.9}Mg_{0.05}Al_{0.05}O₂ (80%) | first: Er | FB | 82.5 | 83.0 |
| | second: LiNi_{1/3}Co_{1/3}Mn_{1/3}O₂ (20%) | second: | | | |
| | | not used | | | |
| Battery A36 | first: LiCo_{0.9}Mg_{0.05}Al_{0.05}O₂ (80%) | first: Er | FB | 82.2 | 82.6 |
| | second: LiNi_{0.5}Co_{0.3}Mn_{0.2}O₂ (20%) | second: | | | |
| | | not used | | | |

The results listed in Table 5 demonstrated that the same effect as that in battery A1 in Experimental example 1 was provided in all the cases where the positive electrode active materials were used.

### 7. Other Matters

As a positive electrode active material that may be used in the present invention, a single compound or a mixture of two or more compounds selected from lithium complex oxides, such as LiCoO₂, LiNiO₂, LiMn₂O₄, LiMnO₂, LiNi₁₋ₓMnₓO₂ (0<x<1), LiNi₁₋ₓCoₓO₂ (0<x<1), and LiNiₓMn_{y}Co_{z}O₂ (0<x, y, z<1, and x+y+z=1), capable of reversibly intercalating and deintercalating lithium ions and phosphate compounds, such as LiFePO₄, having olivine structures is preferably used.

Lithium cobaltates represented by a general formula: LiₓCo_{1-y}M²_{y}O₂ (0.9≦x≦1.1, 0≦y≦0.7, and M² is at least one selected from the group consisting of Ni, Mn, Fe, Ti, Al, Mg, Ca, Sr, Zn, Y, Yb, Nb, and As) are preferably used separately or in combination as a mixture in view of the high-temperature storage characteristics and the cycle characteristics. In the general formula, y is preferably in the range of 0≦y≦0.3.

Examples of the fluoroarene contained in the nonaqueous electrolyte include fluorobenzene, such as monofluorobenzene (FB), difluorobenzene, and trifluorobenzene; fluorotoluene, such as monofluorotoluene and difluorotoluene; alkylbenzene having a fluorine atom on the benzene ring, such as monofluoroxylene; and fluoronaphthalene, such as monofluoronaphthalene. These compounds may be used separately or in combination of two or more thereof. As the fluoroarene, at least one selected from the group consisting of fluorobenzene and fluorotoluene is preferably used. In particular, fluorobenzene is preferred.

In the fluoroarene, the number of fluorine atoms may be appropriately selected, depending on the number of carbon atoms in the arene ring and the number of alkyl groups serving as substituents on the arene ring. In fluorobenzene, the number of fluorine atoms is preferably 1 to 6, more preferably 1 to 4, and still more preferably 1 to 3. In fluorotoluene, the number of fluorine atoms is preferably 1 to 5, more preferably 1 to 3, and still more preferably 1 or 2.

The content M_{FA} of the fluoroarene in a nonaqueous solvent is preferably 2% by mass or more, more preferably 5% by mass or more, and still more preferably 7% by mass or more. M_{FA} is preferably 25% by mass or less, more preferably 20% by mass or less, and still more preferably 15% by mass or less. The lower limits and the upper limits may be appropriately selected and combined. For example, M_{FA} may be in the range of 2% to 25% by mass, 2% to 15% by mass, or 7% to 20% by mass.

When M_{FA} is more than 25% by mass, the ionic conductivity is reduced to reduce the rate characteristics. When M_{FA} is less than 2% by mass, the fluoroarene is not present in an amount sufficient to react with metallic lithium deposited on the negative electrode to form an inert LiF film, so that metallic lithium is liable to be deposited on the surfaces of the negative electrode, thereby reducing the cycle characteristics.

Examples of a nonaqueous solvent that may be used in the present invention include cyclic carbonate, such as ethylene carbonate (EC), propylene carbonate (PC), and butylene carbonate (BC); chain carbonate, such as dimethyl carbonate (DMC), ethyl methyl carbonate (EMC), diethyl carbonate (DEC), and methyl propyl carbonate (MPC); chain ester, such as methyl propionate (MP) and methyl trimethylacetate (MTMA); and cyclic carbonate, such as γ-butyrolactone (GBL) and γ-valerolactone (GVL). These solvents may be used separately or in combination of two or more thereof.

Examples of the electrolyte salt dissolved in the nonaqueous solvent used in the present invention include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₆SO₂)₃, LiAsF₆, LiClO₄, Li₂B₁₀Cl₁₀, and Li₂B₁₂Cl₁₂. These electrolyte salts may be used separately or in combination of two or more thereof. Of these, LiPF₆ (lithium hexafluorophosphate) is particularly preferred. The amount of the electrolyte salt dissolved is preferably in the range of 0.5 to 2.0 mol/L with respect to the nonaqueous solvent.

A compound to stabilize the electrodes is contained in the nonaqueous electrolytic solution used in the present invention. Examples of the compound include cyclic carbonate having a polymerizable carbon-carbon unsaturated bond, such as vinylene carbonate (VC) and vinyl ethylene carbonate (VEC); fluorine atom-containing cyclic carbonate, such as fluoroethylene carbonate (FEC); sultone compounds, such as 1,3-propane sultone (PS); sulfonate compounds, such as methylbenzene sulfonate (MBS); and aromatic compounds (for example, aromatic compounds that do not have a fluorine atom), such as cyclohexylbenzene (CHB), biphenyl (BP), and diphenyl ether (DPE). These additives may be used separately or in combination of two or more thereof. The content of the compound is preferably 10% by mass or less with respect to the total of the nonaqueous electrolyte.

The nonaqueous electrolyte preferably has a viscosity of 3 to 7 mPa·s and more preferably 3.5 to 5 mPa·s at 25° C. In the case where the viscosity of the nonaqueous electrolyte is within the range described above, high discharge characteristics and high rate characteristics are provided even at low temperatures. The viscosity may be measured with, for example, a rotational viscometer equipped with a cone-plate-type spindle.

The positive electrode plate includes the positive electrode collector and a positive electrode active material layer arranged on a surface of the positive electrode collector. Examples of a material for the positive electrode collector include stainless steel, aluminum, aluminum alloys, and titanium. The positive electrode collector may be formed of a non-porous conductive substrate or a porous conductive substrate having a plurality of through holes. Examples of a non-porous collector include metal foil and metal sheets. Examples of a porous collector include metal foil having communicating holes (punched holes), mesh bodies, punching sheets, and expanded metals. The thickness of the positive electrode collector may be selected from a range of 3 to 50 μm.

The positive electrode active material layer may be arranged on each of the surfaces of the positive electrode collector or one of the surfaces. The positive electrode active material layer has a thickness of, for example, 10 to 70 μm. The positive electrode active material layer contains the positive electrode active material and the binder.

Examples of the binder include fluorocarbon resins, such as polyvinylidene fluoride; acrylic resins, such as polymethyl acrylate and ethylene-methyl methacrylate copolymer; and rubber-like materials, such as styrene-butadiene rubber, acrylic rubber, and modifications thereof.

The proportion of the binder is preferably in the range of 0.1 to 10 parts by mass and more preferably 0.5 to 5 parts by mass with respect to 100 parts by mass of the positive electrode active material.

The positive electrode active material layer may be formed by preparing a positive electrode slurry containing the positive electrode active material and the binder and applying the positive electrode slurry to a surface of the positive electrode collector. The positive electrode slurry contains a dispersion medium and may further contain a thickener, a conductive agent, and so forth, as needed.

Examples of the dispersion medium include water; alcohols, such as ethanol; ethers, such as tetrahydrofuran; N-methyl-2-pyrrolidone (NMP); and solvent mixtures thereof.

The positive electrode slurry may be prepared by a method with, for example, a known mixer or kneader. The positive electrode slurry may be applied to a surface of the positive electrode collector by any known coating method with a coater. Typically, the resulting coating film of the positive electrode slurry is dried and rolled. The drying may be air drying or may be performed under heat or reduced pressure.

Examples of the conductive agent include carbon black; conductive fibers, such as carbon fibers; and fluorocarbons. The proportion of the conductive agent is preferably in the range of 0.1 to 10 parts by mass and more preferably 0.5 to 5 parts by mass with respect to 100 parts by mass of the positive electrode active material.

Examples of the thickener include cellulose derivatives, such as carboxymethylcellulose (CMC); and poly(C₂₋₄ alkylene glycol), such as polyethylene glycol. The proportion of the thickener is preferably in the range of 0.1 to 10 parts by mass and more preferably 0.5 to 5 parts by mass with respect to 100 parts by mass of the positive electrode active material.

The negative electrode plate includes the negative electrode collector and a negative electrode active material layer arranged on a surface of the negative electrode collector. Examples of a material for the negative electrode collector include stainless steel, nickel, copper, and copper alloys. Examples of the shape of the negative electrode collector are the same as those of the positive electrode collector. The thickness of the negative electrode collector may be selected from the same range as that of the positive electrode collector.

The negative electrode active material layer may be arranged on each of the surfaces of the negative electrode collector or one of the surfaces. The negative electrode active material layer has a thickness of, for example, 10 to 100 μm.

The negative electrode active material layer contains the negative electrode active material serving as an essential component. Examples of an optional component include a binder, a conductive agent, and a thickener. The negative electrode active material layer may be a deposited film formed by a gas-phase method.

The deposited film may be formed by depositing the negative electrode active material on a surface of the negative electrode collector using a gas-phase method, for example, a vacuum evaporation method, a sputtering method, or an ion plating method. In this case, examples of the negative electrode active material that may be used include silicon, silicon compounds, and lithium alloys as described below.

The negative electrode active material layer may be formed by preparing a negative electrode slurry containing the negative electrode active material and a binder and applying the negative electrode slurry to a surface of the negative electrode collector. The negative electrode slurry contains a dispersion medium and may further contain a conductive agent, a thickener, and so forth, as needed. The negative electrode slurry may be prepared in the same way as the method for preparing the positive electrode slurry. The application of the negative electrode slurry may be performed in the same way as the application of the positive electrode.

Examples of the negative electrode active material include carbon materials; silicon and silicon compounds; and lithium alloys each containing at least one selected from tin, aluminum, zinc, and magnesium.

Examples of carbon materials include graphite, coke, carbon undergoing graphitization, graphitized carbon fibers, and amorphous carbon. Examples of amorphous carbon include graphitizable carbon materials (soft carbon), which are readily graphitized by heat treatment at a high temperature (for example, 2800° C.); and non-graphitizable carbon materials, which are little graphitized by the heat treatment (hard carbon). Soft carbon has a structure in which microcrystallites like graphite are arranged in substantially the same direction. Hard carbon has a turbostratic structure.

Examples of silicon compounds include silicon oxide SiO_{α} (0.05<α<1.95). α is preferably in the range of 0.1 to 1.8 and more preferably 0.15 to 1.6. In the silicon oxide, silicon may be partially replaced with one or two or more elements. Examples of such elements include B, Mg, Ni, Co, Ca, Fe, Mn, Zn, C, N, and Sn.

As the negative electrode active material, graphite particles are preferably used. The term “graphite particles” is a generic name for particles containing a region having a graphite structure. Thus, the graphite particles include particles of natural graphite, artificial graphite, graphitized mesophase carbon, and so forth. A single type of graphite particles may be used. Alternatively, two or more types of graphite particles may be used in combination.

The degree of graphitization of the graphite particles is preferably in the range of 0.65 to 0.85 and more preferably 0.70 to 0.80. Here, the value (G) of the degree of graphitization is determined by calculating the value (a₃) of the interplanar spacing d₀₀₂ of the 002 plane determined by XRD analysis of the graphite particles and substituting the value for a₃ in the following expression:

G=(a₃−3.44)/(−0.086)

The value G is an index of the degree of graphitization and indicates how close the measured value is to the value of d₀₀₂ (a₃=3.354) of a perfect crystal.

The graphite particles preferably have an average particle diameter (D50) of 5 to 40 μm, more preferably 10 to 30 μm, and still more preferably 12 to 25 μm.

The average particle diameter (D50) is a median diameter of a particle size distribution on a volume basis. The average particle diameter is determined with, for example, a laser diffraction/scattering particle size distribution analyzer (LA-920) manufactured by Horiba, Ltd.

The graphite particles preferably have an average sphericity of 80% or more and more preferably 85% to 95%. When the average sphericity is within the range described above, the sliding properties of the graphite particles in the negative electrode active material layer are improved. This advantageously results in improvements in the filling properties of the graphite particles and the adhesive strength of the graphite particles.

The average sphericity is represented by 4πS/L²×100(%) (where S denotes the area of the orthogonally projected image of each of the graphite particles, and L denotes the length of the circumference of the orthogonally projected image). For example, the average sphericity of freely-selected 100 graphite particles is preferably within the range described above.

The graphite particles preferably have a BET specific surface area of 2 to 6 m²/g and more preferably 3 to 5 m²/g. When the BET specific surface area is within the range described above, the sliding properties of the graphite particles in the negative electrode active material layer are improved. This advantageously results in improvements in the adhesive strength of the graphite particles.

A binder, a dispersion medium, and a conductive agent, and a thickener that are the same as those used for the positive electrode slurry may be used for the negative electrode slurry.

The binder preferably is in the form of particles and has rubber elasticity. As the binder, a polymer containing styrene units and butadiene units (for example, styrene-butadiene rubber (SBR)) is preferred. The polymer has excellent elasticity and is stable at a negative electrode potential.

The binder in the form of particles preferably has an average particle diameter of 0.1 to 0.3 μm and more preferably 0.1 to 0.25 μm. The average particle diameter of the binder may be determined by, for example, taking a SEM photograph of 10 binder particles with a transmission electron microscope (manufactured by JEOL Ltd., acceleration voltage: 200 kV) and calculating the average value of the maximum diameters of these particles.

The proportion of the binder is preferably in the range of 0.5 to 2.0 parts by mass and more preferably 0.5 to 1.5 parts by mass with respect to 100 parts by mass of the negative electrode active material. The binder being in the form of particles and having a small average particle diameter has a high probability of coming into contact with the surfaces of the negative electrode active material, so that even when a small amount of the binder is used, sufficient adhesion is provided.

The proportion of the conductive agent is preferably, but not particularly limited to, 0 to 5 parts by mass with respect to 100 parts by mass of the negative electrode active material. The proportion of the thickener is preferably, but not particularly limited to, 0 to 5 parts by mass with respect to 100 parts by mass of the negative electrode active material.

The negative electrode plate may be produced in the same way as the method for producing the positive electrode plate. Each of the negative electrode mixture layers has a thickness of, for example, 30 to 110 μm.

As the separator of the present invention, for example, a microporous film, a non-woven fabric, or a woven fabric composed of a resin may be used. Examples of the resin contained in the separator include polyolefin, such as polyethylene and polypropylene; polyamide; polyamide-imide; polyimide; and cellulose. The separator has a thickness of, for example, 5 to 100 pint.

The shape of the nonaqueous electrolyte secondary battery of the present invention may be, but is not particularly limited to, a cylindrical shape, a flat shape, a coin shape, a prismatic shape, or the like. The nonaqueous electrolyte secondary battery may be produced by a known method, depending on the shape of the battery. A cylindrical battery or prismatic battery may be produced by, for example, winding the positive electrode, the negative electrode, and the separator provided therebetween to form the electrode body and arranging the electrode body and the nonaqueous electrolyte in a battery case.

The electrode body is not limited to a wound body and may be a laminated body or fanfold body. The shape of the electrode body may be a cylindrical shape or a flat shape with an oblong end face perpendicular to the wound core, depending on the shape of the battery or the battery case.

As a material for the battery case, for example, aluminum, an aluminum alloy (for example, an alloy containing a very small amount of manganese, copper, or the like), or steel sheet may be used.

### INDUSTRIAL APPLICABILITY

The positive electrode active material and the nonaqueous electrolyte of the present invention inhibit the oxidative decomposition of the electrolytic solution in a high-temperature environment to markedly improve the high-temperature storage characteristics and the cycle characteristics and thus are useful for nonaqueous electrolyte secondary batteries used in electronic devices, such as cellular phones, personal computers, digital still cameras, game machines, and portable music players.

### REFERENCE SIGNS LIST

10 flat spiral electrode body
11 prismatic battery case
12 seal plate
13 negative electrode terminal
14 positive electrode lead
15 negative electrode lead
16 gasket
17 sealing plug
17a inlet
18 frame
21 nonaqueous electrolyte secondary battery

1. A nonaqueous electrolyte secondary battery comprising:
a positive electrode plate containing a positive electrode active material;
a negative electrode plate containing a negative electrode active material; and
a nonaqueous electrolyte,
wherein the positive electrode active material is a lithium transition metal complex oxide,
at least one selected from rare-earth hydroxide and rare-earth oxyhydroxide is present on a surface of the positive electrode active material, and
the nonaqueous electrolyte contains a fluoroarene.

2. The nonaqueous electrolyte secondary battery according to claim 1, wherein each of the rare-earth hydroxide and the rare-earth oxyhydroxide is a hydroxide or oxyhydroxide of at least one selected from Er, Sm, Nd, Yb, Tb, Dy, Ho, Tm, and Lu.

3. The nonaqueous electrolyte secondary battery according to claim 1, wherein the content of the at least one selected from the rare-earth hydroxide and the rare-earth oxyhydroxide is in the range of 0.01% to 0.30% by mole with respect to the positive electrode active material.

4. The nonaqueous electrolyte secondary battery according to claim 1, wherein the fluoroarene is at least one selected from the group consisting of fluorobenzenes and fluorotoluenes.

5. The nonaqueous electrolyte secondary battery according to claim 4, wherein the fluoroarene is a fluorobenzene.

6. The nonaqueous electrolyte secondary battery according to claim 1, wherein the positive electrode active material contains at least one selected from lithium transition metal complex oxides, LiMn₂O₄, and LiFePO₄, the lithium transition metal complex oxides being represented by LiMO₂ (where M represents at least one of Co, Ni, and Mn) capable of reversibly intercalating and deintercalating lithium ions.

7. The nonaqueous electrolyte secondary battery according to claim 2, wherein the content of the at least one selected from the rare-earth hydroxide and the rare-earth oxyhydroxide is in the range of 0.01% to 0.30% by mole with respect to the positive electrode active material.
